(19) United States
(12) Patent Application Publication
(10) Pub. No.: US 2010/0027513 A1
(43) Pub. Date: Feb. 4, 2010

(54) Base Station Device and Control Method for the Same

(75) Inventor: Goro Ikeda, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/159,087

(22) PCT Filed: Dec. 22, 2006
(86) PCT No.: PCT/JP2006/325612

§ 371 Date: Sep. 11, 2009

(30) Foreign Application Priority Data
Dec. 27, 2005 (JP) 2005-376534

(51) Int. Cl. H04B 7/212; H04W 4/00

(52) U.S. Cl. 370/337; 370/329

(57) ABSTRACT

A base station device (12) is capable of multiplex communications with a plurality of mobile station devices using space division multiple access on a communication channel at a specified carrier frequency, receives a start request for multiplex communications from the mobile station device in accordance with a presence or absence of another communication signal on the communication channel, and allocates the communication channel to the mobile station device that has made the start request in response to the start request. The base station device (12) includes a transmission control unit (22) for performing intermittent transmission of communication signals to the mobile station device already in communication on the communication channel among the plurality of mobile station devices.

### TECHNICAL FIELD

The present invention relates to a base station device and a control method for the base station device, and more particularly relates to a base station device and a control method for the base station device for performing multiplex communications with a plurality of mobile station devices using space division multiple access at a specified carrier frequency.

### BACKGROUND ART

Space division multiple access (SDMA) is a wireless communication technique in which the same carrier frequency is spatially divided, and the utilization efficiency of the frequency is increased. In mobile communication systems using SDMA, an adaptive array antenna is installed in a base station device, transmission beams having respectively different directivity patterns are formed for each of the mobile station devices, and radio waves are simultaneously transmitted to each of the mobile station devices. When the base station device transmits signals to the mobile station device, the base station device performs a control so that transmission beams are directed toward the mobile station device as the transmission partner by adaptive beamforming, and the null points of the directivity pattern are directed toward the mobile station devices other than the transmission partner by adaptive null steering. Similarly, when the base station device receives signals from the mobile station devices as well, the reception beams are directed toward the mobile station device as the reception counterpart (in the desired wave direction) by adaptive beamforming, and the null points of the directivity pattern are directed toward the mobile station devices other than the reception counterpart (in the interference wave direction) by adaptive null steering. Accordingly, SDMA mobile communication systems increase the utilization efficiency of the frequency by simultaneously allocating the same carrier frequency to a plurality of mobile station devices while maintaining communication quality between the base station device and mobile station devices.

When the base station device assigns a communication channel according to a carrier frequency already in use in communication with the first mobile station device to the second mobile station device by spatial multiplexing, the base station device notifies the second mobile station device of this communication channel to be used in communication with the second mobile station device. The second mobile station device performs a carrier sense (interference wave measurement) with respect to this communication channel notified from the base station device. Carrier sense refers to an investigation of whether or not an interference wave signal having a certain power or greater is received on the designated communication channel. If an interference wave signal is detected on the communication channel, communications cannot be started in this communication channel. The reason is that a risk is presented that the communication quality of the second mobile station device will deteriorate by the interference wave, and a risk is also presented that the communications of the second mobile station device will interfere with the communications of other communication devices.

The base station device in communication with the first mobile station device via the communication channel performs a control for directing the transmission beam toward the first mobile station device by adaptive beamforming; however, a control for directing the null points of the directivity pattern toward the other mobile station devices including the second mobile station device is not performed. When the second mobile station device performs a carrier sense in this state, the second mobile station device detects the communication signals transmitted from the base station device toward the first mobile station device as interference wave signals; accordingly, the carrier sense cannot be passed. In this respect, a technique is disclosed in patent document 1 shown below for reliably causing the second mobile station device to pass a carrier sense by stopping the transmission of communication signals to the first mobile station device until carrier sensing for the communication channel is completed by the second mobile station device after the base station device has notified the second mobile station device of the communication channel.

[Patent Document 1] Japanese Laid-Open Patent Application No. 2004-248001.

Furthermore, a method is also conceivable in which the base station device determines the direction of the second mobile station device on the basis of a connection request signal or the like from the second mobile station device, and performs null control in this direction. However, in cases where the frequency of the connection request signal or the like and that of the communication channel differ, the precision of null control for the second mobile station device is poor, and it may not be possible to pass a carrier sense. Accordingly, it is more desirable to stop the transmission of communication signals to the first mobile station device completely.

### DISCLOSURE OF THE INVENTION

### Problems to be Solved by the Invention

In actual SDMA mobile communication systems, the timing at which a carrier sense is started and the time required for the carrier sense differ according to the type of the mobile station devices. Accordingly, in the above-mentioned conventional technique, it is necessary for the base station device to set the transmission stopping period for the first mobile station device at a certain length in order to allow any type of mobile station device to pass a carrier sense.

However, if the base station device stops transmission to the first mobile station device for a long period of time, a risk is presented that the first mobile station device will detect this as a frame error, and will initiate a handover. If this occurs, the communication channel used in communication with the first mobile station device by the base station device becomes an idle channel, and spatial multiplex communications end up being unsuccessful in this communication channel.

The present invention was devised in light of the abovementioned conventional problems. It is an object of the present invention to provide a base station device and a control method for the base station device which can suppress the occurrence of frame errors caused by carrier sensing performed in space division multiple allocation, and improve the success rate of space division multiple allocation.

### Means for Solving the Problem

In order to achieve the abovementioned object, a base station device according to the present invention is a base station device which is capable of multiplex communications with a plurality of mobile station devices using space division multiple access on a communication channel at a specified carrier frequency, receives a start request for multiplex communications from the mobile station device in accordance with a presence or absence of another communication signal on the communication channel, and allocates the communication channel to the mobile station device that has made the start request in response to the start request, the base station device includes transmission control means for performing intermittent transmission of communication signals to the mobile station device already in communication on the communication channel among the plurality of mobile station devices.

Furthermore, the base station device control method according to the present invention is a control method for a base station device which is capable of multiplex communications with a plurality of mobile station devices using space division multiple access on a communication channel at a specified carrier frequency, receives a start request for multiplex communications from the mobile station device in accordance with a presence or absence of another communication signal on the communication channel, and allocates the communication channel to the mobile station device that has made the start request in response to the start request, wherein communication signals are intermittently transmitted to the mobile station device already in communication on the communication channel among the plurality of mobile station devices.

According to the present invention, the occurrence of frame errors can be suppressed to a greater extent than in a case in which the transmission of communication signals by the base station device is stopped for a long period of time, and the mobile station device can be caused to perform a carrier sense while the transmission is stopped. Accordingly, the base station device can suppress the occurrence of frame errors caused by carrier sensing performed in space division multiple allocation, and improve the success rate of space division multiple allocation.

According to another aspect of the present invention, the transmission control means performs the intermittent transmission of the communication signals to the mobile station device already in communication on the communication channel among the plurality of mobile station devices, after notification of the communication channel is provided to the mobile station device that has made the start request. According to such an arrangement, the base station device can suppress the occurrence of frame errors caused by carrier sensing performed in space division multiple allocation, and can improve the success rate of space division multiple allocation, without greatly lowering the throughput of the mobile station device already in communication.

According to another aspect of the present invention, the base station device further includes transmission pattern storage means for storing a plurality of transmission patterns for the intermittent transmission, wherein the transmission control means retrieves one of the transmission patterns stored in the transmission pattern storage means, and intermittently transmits the communication signals to the mobile station device already in communication on the communication channel among the plurality of mobile station devices, in accordance with this transmission pattern. According to such an arrangement, the base station device can perform transmission control of communication signals on the basis of one of a plurality of intermittent transmission patterns stored beforehand; accordingly, the base station can suppress the occurrence of frame errors caused by carrier sensing performed in space division multiple allocation, and improve the success rate of space division multiple allocation.

According to another aspect of the present invention, the base station device further includes successful transmission pattern storage means for storing the transmission pattern for the intermittent transmission performed by the transmission control means in association with identification information for the mobile station device that has made the start request, wherein in a case where a start request is again made by the mobile station device that has made the start request, the transmission control means retrieves the transmission pattern stored in the successful transmission pattern storage means in association with identification information for this mobile station device, and intermittently transmits communication signals to the mobile station device already in communication on the communication channel among the plurality of mobile station devices, in accordance with this transmission pattern. According to such an arrangement, the base station device can perform the transmission control of communication signals on the basis of intermittent transmission patterns successful in space division multiple allocation; accordingly, the base station device can suppress the occurrence of frame errors caused by carrier sensing performed in space division multiple allocation, and improve the success rate of space division multiple allocation.

According to another aspect of the present invention, the transmission pattern includes information specifying a timing at which the transmission of the communication signals to the mobile station device already in communication on the communication channel among the plurality of mobile station devices is stopped, and a period for which the transmission is stopped. According to such an arrangement, the base station device can perform the transmission control of communication signals on the basis of an optimal intermittent transmission pattern prepared beforehand for each type of mobile station device; accordingly, the base station device can suppress the occurrence of frame errors caused by carrier sensing performed in space division multiple allocation, and improve the success rate of space division multiple allocation.

According to another aspect of the present invention, the transmission control means limits the stopping of the transmission of the communication signals on the communication channel until a predetermined period of time has elapsed after once stopping the transmission of the communication signals on the communication channel. Furthermore, the transmission control means may initiate transmission after once stopping the transmission of the communication signals on the communication channel, and stop the transmission on a communication channel differing from the communication channel on which the transmission of the communication signals was once stopped when the transmission is again stopped. According to such an arrangement, the base station device can suppress the occurrence of frame errors caused by carrier sensing performed in space division multiple allocation, and improve the success rate of space division multiple allocation, without greatly lowering the throughput of the mobile station device already in communication.

According to another aspect of the present invention, the base station device is capable of multiplex communications with the plurality of mobile station devices using time division multiple access and space division multiple access; the base station device includes slot for multiplexing selection means for selecting any one of time slots already allocated to at least one of the mobile station devices other than the mobile station device that has made the start request as a slot for multiplexing that is allocated to the mobile station device that has made the start request; and the communication channel is specified by the slot for multiplexing selected by the slot for multiplexing selection means and the specified carrier frequency. According to such an arrangement, the base station device using time division multiple access can suppress the occurrence of frame errors caused by carrier sensing performed in space division multiple allocation, and improve the success rate of space division multiple allocation.

### BRIEF DESCRIPTION OF THE DRAWINGS

FIG. 1 is a configuration diagram of a mobile communication system according to an embodiment of the present invention;

FIG. 2 is a block diagram of a base station device according to an embodiment of the present invention;

FIG. 3 is a diagram showing an example of a transmission pattern storage unit;

FIG. 4 is a diagram showing an example of a successful transmission pattern storage unit;

FIG. 5 is a diagram showing a relationship between a carrier sensing time of the mobile station device and a transmission stopping time of the base station device;

FIG. 6 is a diagram illustrating a processing for spatially multiplexing calls;

FIG. 7 is a sequence diagram illustrating a processing for spatially multiplexing calls;

FIG. 8 is a sequence diagram illustrating a processing for spatially multiplexing calls;

FIG. 9 is a sequence diagram illustrating a processing for spatially multiplexing calls;

FIG. 10 is a diagram illustrating a processing for spatially multiplexing calls; and

FIG. 11 is a sequence diagram illustrating the multiple allocation processing of communication channels in a conventional mobile communication system.

### BEST MODE FOR CARRYING OUT THE INVENTION

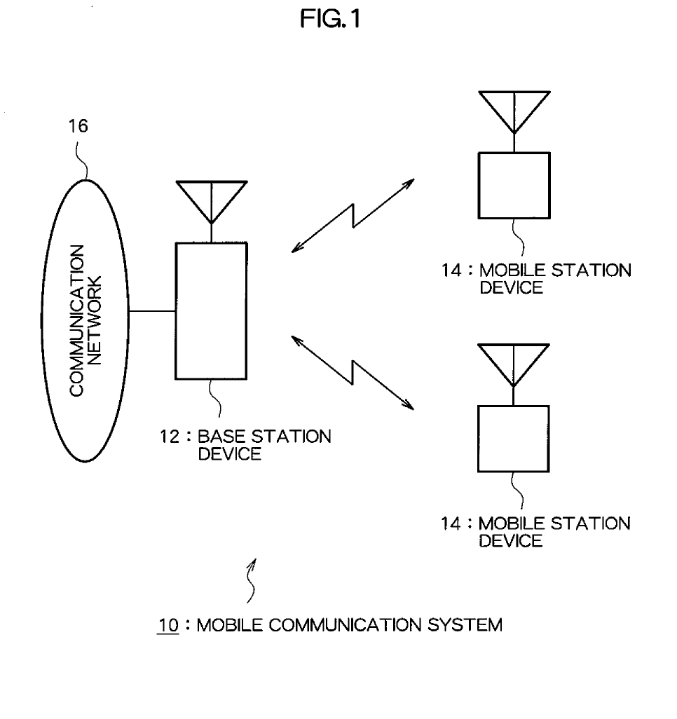

Embodiments of the present invention will be described below with reference to the attached figures. FIG. 1 is a diagram showing the configuration of a mobile communication system 10 according to an embodiment of the present invention. As shown in FIG. 1, the mobile communication system 10 includes a base station device 12 which is connected to a communication network 16 via a wired transmission line, and a plurality of mobile station devices 14 which are connected to the base station device 12 via wireless transmission channels. In addition to space division multiple access, the mobile communication system 10 can also use time division multiple access (TDMA).

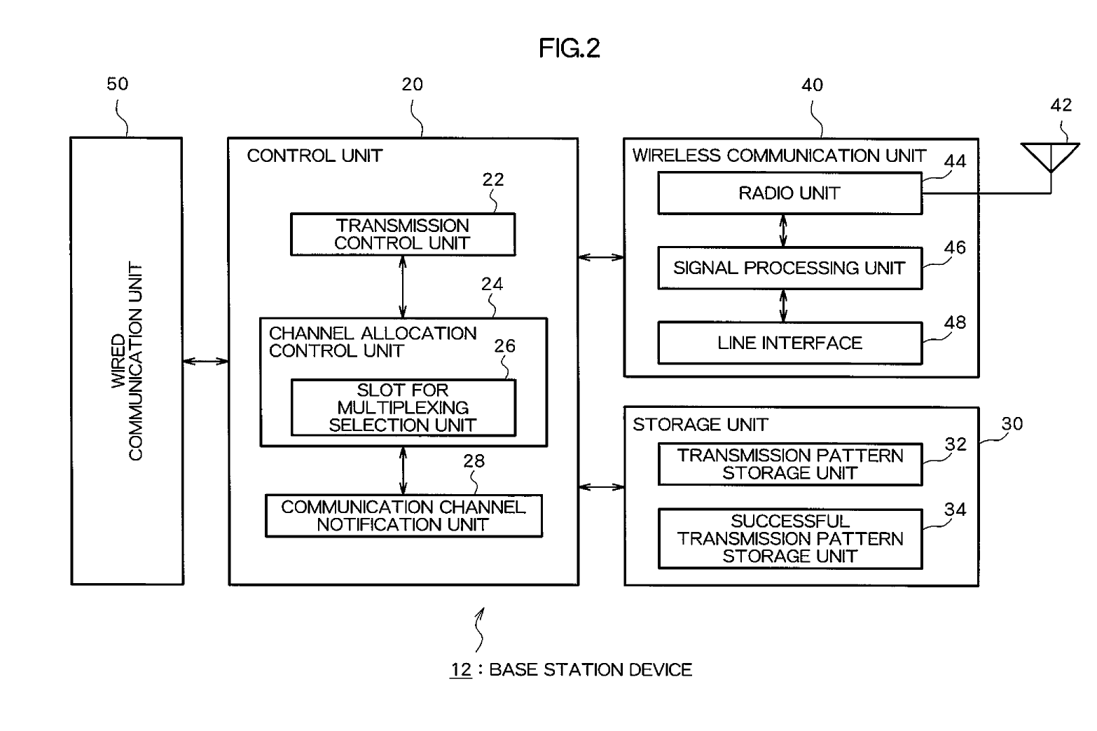

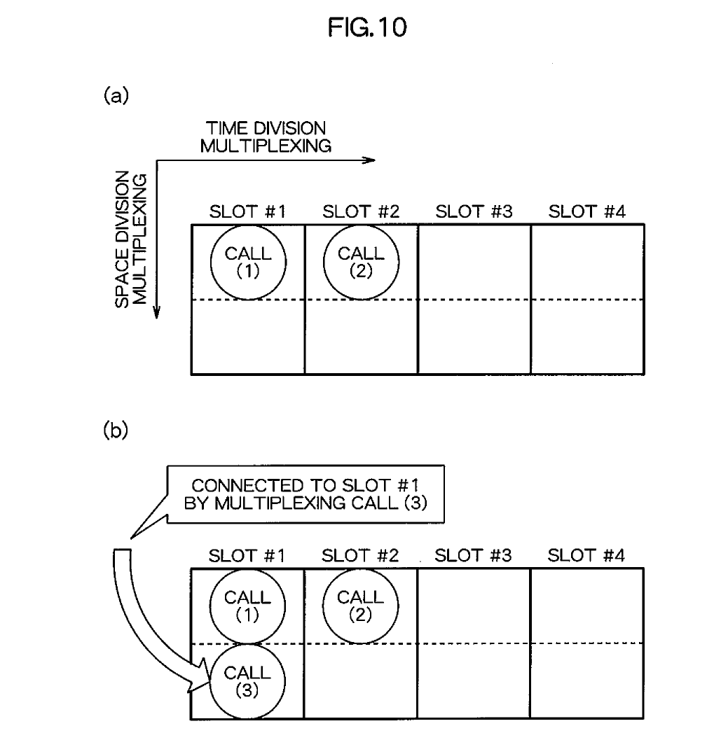

FIG. 2 is a block diagram showing the configuration of the base station device 12. The base station device 12 includes a control unit 20, a storage unit 30, a wireless communication unit 40, and a wired communication unit 50. For example, as shown in FIG. 10(a), the base station device 12 multiplexes four time division channels in one TDMA frame having a predetermined time period, and further accommodates calls from at least two mobile station devices 14 per channel by spatial multiplexing. The same carrier frequency is used in each of the time slots.

As shown in FIG. 2, an adaptive array antenna 42 is connected to a radio unit 44. The radio unit 44 has a transmission unit and a receiving unit; this radio unit 44 controls the adaptive array antenna 42 by time division, and switches between transmission and reception. The transmission unit of the radio unit 44 has an up-converter, a power amplifier and the like; and converts signals input from the signal processing unit 46 from baseband signals into radio-frequency signals, amplifies these signals to the transmission output level, and outputs the signals to the adaptive array antenna 42. The receiving unit of the radio unit 44 includes a low-noise amplifier, a down-converter, and the like; and converts the signals received by the adaptive array antenna 42 from radio-frequency signals into baseband signals, amplifies the signals and outputs the signals to a signal processing unit 46.

The signal processing unit 46 performs a control relating to the formation of the directivity pattern, i.e., it separates, extracts and demodulates the spatially multiplexed signals received from the respective mobile station device 14 that are input from the radio unit 44, and outputs these signals to the line interface 48. The signal processing unit 46 modulates transmission signals input from the line interface 48, and performs a control that produces signals weighted for spatial multiplexing so as to be transmitted to the desired mobile station device 14, and outputs these signals to the radio unit 44. The signal processing unit 46 performs parallel processing signals of at least two calls that are spatially multiplexed on one time division channel.

The wired communication unit 50 is connected to a communication network 16 by a wired transmission line such as an ISDN line or the like, and is connected to the signal processing unit 46 via a control unit 20; a plurality of signals (voice or data baseband signals) are exchanged between a plurality of communication lines and the signal processing unit 46.

The control unit 20 includes a transmission control unit 22, a channel allocation control unit 24, and a communication channel notification unit 28; and controls the base station device 12 as a whole. The transmission control unit 22 performs a transmission control process that causes the radio unit 44 to transmit intermittently to the mobile station devices 14. The channel allocation control unit 24 includes a slot for multiplexing selection unit 26; this channel allocation control unit selects a call and a time slot for spatial multiplexing, and controls the allocation of communication channels. The communication channel notification unit 28 notifies the mobile station device 14 making a connection request for multiplex communications of the communication channel determined by the channel allocation control unit 24. The control unit 20 is constructed from a CPU, memory, and the like.

The storage unit 30 includes a transmission pattern storage unit 32 and a successful transmission pattern storage unit 34; and stores transmission control information that is used in the transmission control processing performed by the transmission control unit 22. For example, the storage unit 30 is constructed from the memory of the control unit 20.

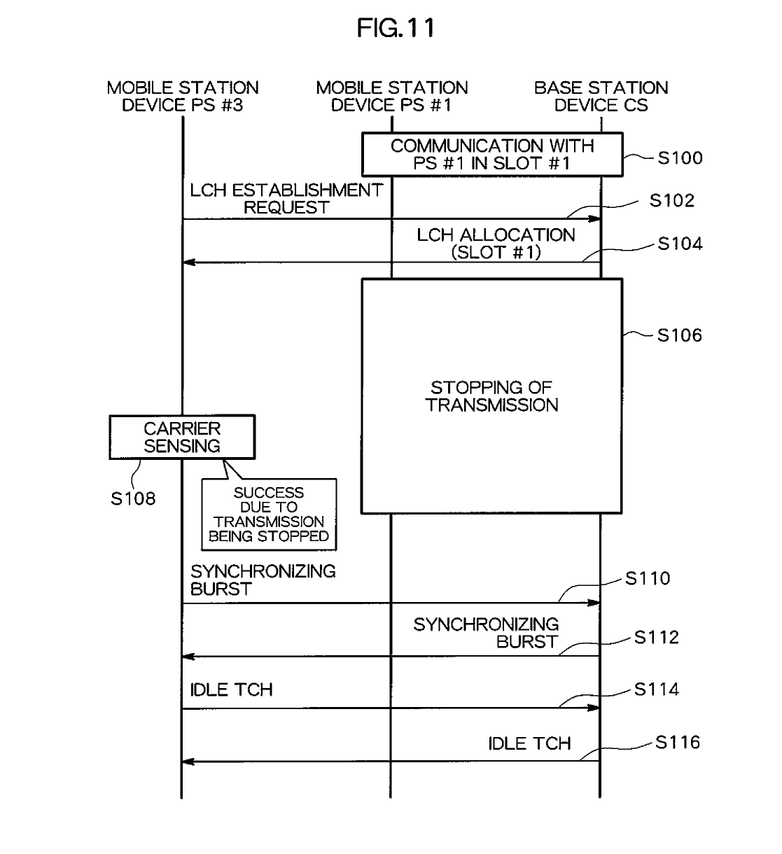

FIG. 10 is a diagram illustrating a process in which the base station device 12 performs spatial multiplexing of calls from two mobile station devices 14 in a single time division channel. FIG. 10(a) shows a state prior to the spatial multiplexing of the calls. The channel relating to the slot 1 (hereafter referred to as “channel 1”) is used only for the call 1 of the first mobile station device 14 (hereafter referred to as “PS1”), and the channel relating to the slot 2 (hereafter referred to as “channel 2”) is used only for the call 2 of the second mobile station device 14 (hereafter referred to as “PS2”). Respective specified carrier frequencies are allocated to the respective channels. A description shall be provided with reference to FIG. 11 of a process for further allocating channel 1 already in use in communications by call 1 to call 3 from the third mobile station device 14 (hereafter referred to as “PS3”) newly making a channel establishment request from this state. As a result of this process, the allocation state of the communication channels changes from the state shown in FIG. 10(a) to the state shown in FIG. 10(b). Below, for convenience, calls that are already in communication in communication channels for multiplexing will be referred to as “calls to be multiplexed,” and calls to which the communication channels are newly allocated will be referred to as “multiplex calls.”

In the state shown in FIG. 10(a), PS1 is already in communication with the base station device 12 (hereafter referred to as “CS”) using channel 1 (S100). Here, when PS3 transmits a connection request signal (LCH establishment request signal) to CS (S102), CS determines a communication channel that is to be allocated to PS3. In the example shown in FIG. 11, call 3 of PS3 is selected as a multiplex call in the channel allocation control unit 24, and slot 1 allocated to call 1 of PS1 is selected as a slot for multiplexing by the slot for multiplexing selection unit 26. The communication channel notification unit 28 notifies PS3 with information relating to the channel 1 selected by the slot for multiplexing selection unit 26 (S104). Specifically, information including the slot 1 and the carrier frequency used in the slot 1 is sent to PS3 by the communication channel notification unit 28. Following the notification regarding the communication channel, CS stops the transmission of signals to PS1 already in communication on the channel 1 for a predetermined time by control of the transmission control unit 22 (S106). On the other hand, when PS3 receives information relating to the communication channel (channel 1) from CS, PS3 performs a carrier sense on the communication channel (S108). Since CS stops transmission to PS1 while PS3 is performing the carrier sense, PS3 does not detect transmission signals to PS1 as interference waves.

When PS3 passes the carrier sense, PS3 transmits a synchronizing burst signal (synchronizing control signal) used for establishing synchronization to CS using the communication channel notified from CS (S110). CS resumes transmission to PS1 at the timing at which CS receives this synchronizing burst signal from PS3, or at a timing at which a predetermined period of time has elapsed after stopping the transmission to PS1 as preset by a timer or the like. When CS receives the synchronizing burst signal from PS3, CS transmits a synchronizing burst signal to PS3 as a response to this synchronizing burst signal (S112). The multiplexing to the channel 1 of the call 3 which is the multiplex call is completed at the timing at which synchronization is established between CS and PS3, and the state shown in FIG. 10(b) is obtained. Next, as a result of receiving the synchronizing burst signal from CS, PS3 judges that synchronization has been established, and transmits a communication signal to CS using the communication channel allocated by CS (S114). This communication signal may be an idle signal, or may be a significant signal such as voice, data or the like. CS also similarly transmits a communication signal to PS3 using the communication channel (S116).

In an actual SDMA mobile communication system, as described above, the timing at which a carrier sense is started and the time required for the carrier sense differ according to the type of the mobile station devices. FIG. 5 shows the number of frames (frame period of 5 milliseconds) up to the start of a carrier sense from the time at which notification of a communication channel is received, and the number of frames required in order to perform carrier sensing for various types of mobile station devices. In FIG. 5, for example, in the case of PS1, the number of frames from the reception of communication channel notification to the start of a carrier sense is 2, and the number of frames required in order to perform the carrier sense is 5; meanwhile, in the case of PS13, the number of frames up to the start of a carrier sense is 22, and the number of frames required in order to perform the carrier sense is 7. It is seen from these examples as well that the time at which a carrier sense is started and the time period required for the carrier sense vary greatly according to the type of mobile station devices used. Accordingly, in a conventional system, in order to allow any type of mobile station device to pass a carrier sense in a reliable manner, it is necessary to set the transmission stopping time at a fairly long period in CS. According to such an arrangement, a carrier sense can be reliably passed with a single transmission stoppage. However, if precedence is given to the pass of carrier sensing and the transmission stopping time is set at an excessively long time, the mobile station device side on which transmission is stopped receives no signals from CS that inherently should have been transmitted; accordingly, there is a risk that the mobile station device detects this as a frame error and initiates a handover. As a result, it becomes impossible to spatially multiplex calls of a plurality of mobile station devices on a single communication channel.

Accordingly in the base station device 12 according to the present embodiment, as indicated by the transmission stopping times 1 through 3 shown in FIG. 5, spatial multiplexing of calls can be accomplished at any timing by repeating intermittent transmissions using various transmission patterns while suppressing the occurrence of frame errors in the mobile station device 14 involved in a call to be multiplexed by shortening the respective transmission stopping times. Specifically, after notification of a communication channel for multiplexing to the mobile station device 14 involved in the multiplex call, the transmission control unit 22 according to the present embodiment performs the intermittent transmission of communication signals to the mobile station device involved in the call to be multiplexed that is already in communication on the communication channel. According to such an arrangement, the timing of a carrier sense and the timing of transmission stoppage tend not to match, so that the probability that a carrier sense will not be passed is increased; on the other hand, an increase in the frame error rate can be suppressed, and the initiation of handover can be prevented.

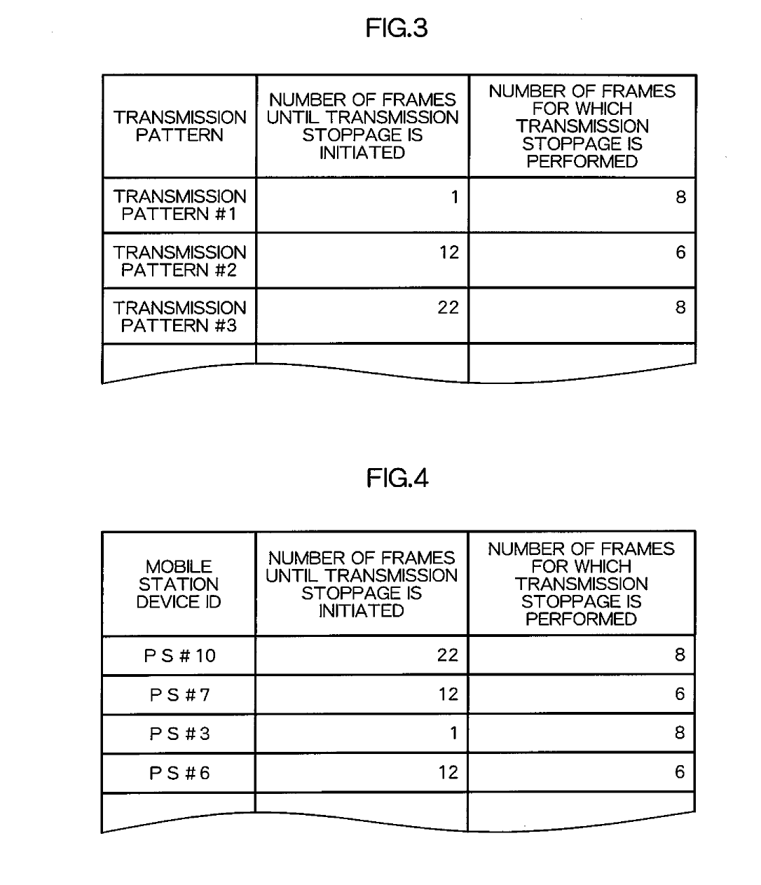

Furthermore, the transmission control unit 22 may also read out any of the transmission patterns for intermittent transmission store in the transmission pattern storage unit 32, and perform the intermittent transmission of communication signals to the mobile station device involved in the call to be multiplexed in accordance with this transmission pattern. FIG. 3 is a diagram showing an example of the transmission pattern storage unit 32. As shown in FIG. 3, the transmission pattern storage unit 32 stores a plurality of transmission patterns for intermittent transmission in association with transmission pattern numbers. The intermittent transmission pattern may include information specifying the number of frames up to the stopping of the transmission of communication signals to the mobile station device 14 involved in a call to be multiplexed after notification regarding a communication channel provided to the mobile station device 14 involved in a multiplex call, and a time period for which the transmission is stopped.

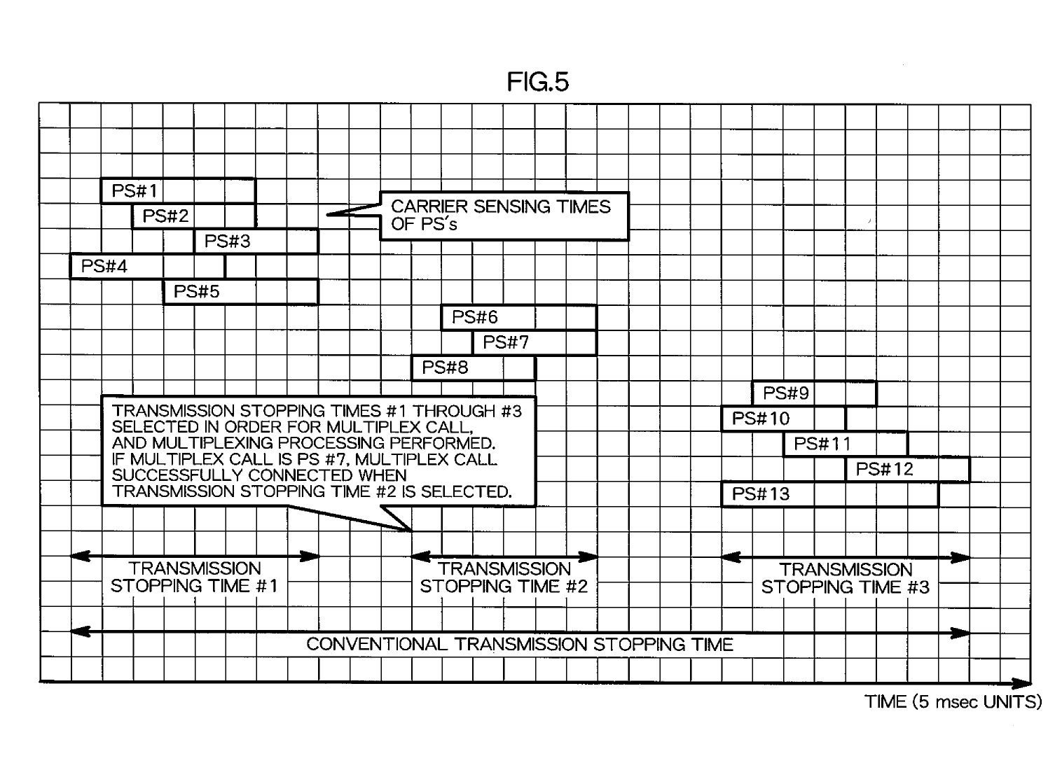

Furthermore, the transmission pattern for intermittent transmission in cases where the mobile station device 14 making the start request for multiplex communications has passed a carrier sense may also be stored in the successful transmission pattern storage unit 34 in association with identification information for the mobile station device 14. Moreover, in cases where a start request for multiplex communications is again made by the mobile station device 14, the transmission pattern for intermittent transmission may be read out from the successful transmission pattern storage unit 34 in association with identification information for this mobile station device 14, and intermittent transmission of communication signals may be performed to the mobile station device in communication using a communication channel for multiplexing in accordance with the transmission pattern. FIG. 4 is a diagram showing an example of the successful transmission pattern storage unit 34. As shown in FIG. 4, the successful transmission pattern storage unit 34 stores transmission patterns for intermittent transmission in association with identification information for mobile station devices 14. Furthermore, the successful transmission pattern storage unit 34 may store transmission pattern numbers in the transmission pattern storage unit 32 in association with identification information for the mobile station devices 14.

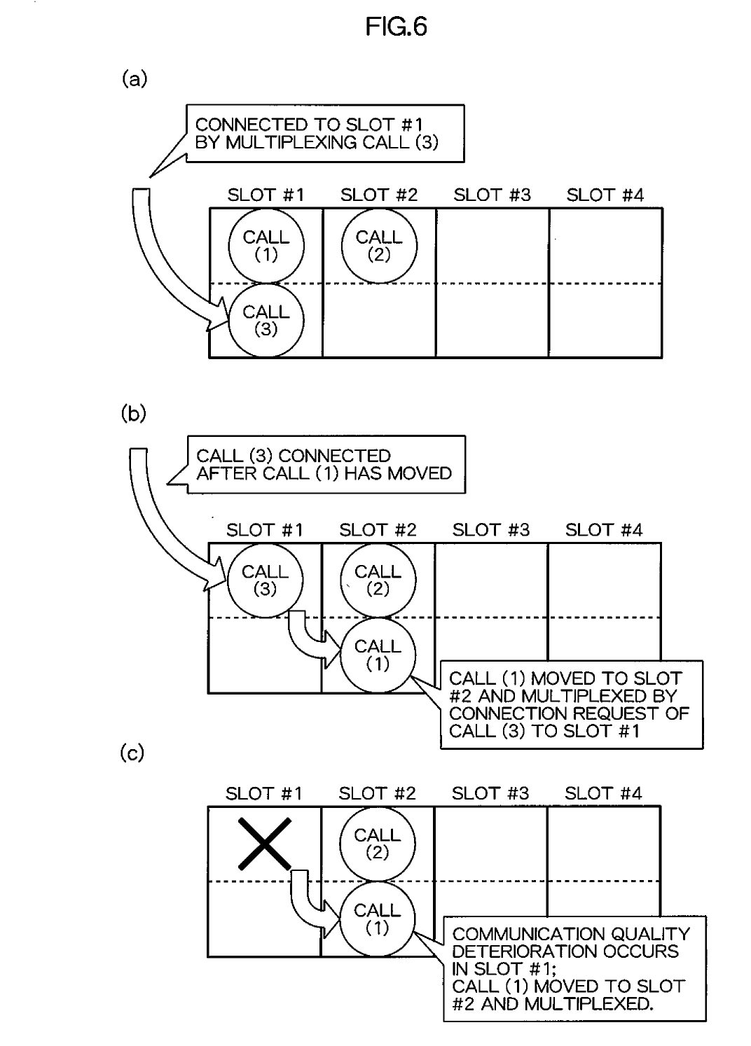

Next, the spatial multiplexing processing of calls according to the present embodiment will be described with reference to FIGS. 6 through 9. FIG. 6 shows typical cases in which the base station device 12 performs the multiple allocation of a multiplex call on a communication channel in use in communications. FIG. 6(a) shows a case in which the channel 1 in use by the call 1 is allocated to the call 3 newly requesting a channel establishment. FIG. 6(b) show a case in which when the call 3 newly requests a channel establishment, the channel 2 in use by the call 2 is multiple-allocated to the call 1 using the channel 1, after which the idle channel 1 is allocated to the call 3. FIG. 6(c) shows a case in which the communication quality on the channel 1 in use by the call 1 has deteriorated, and the channel 2 with good communication quality in use by the call 2 is therefore multiple-allocated to the call 1.

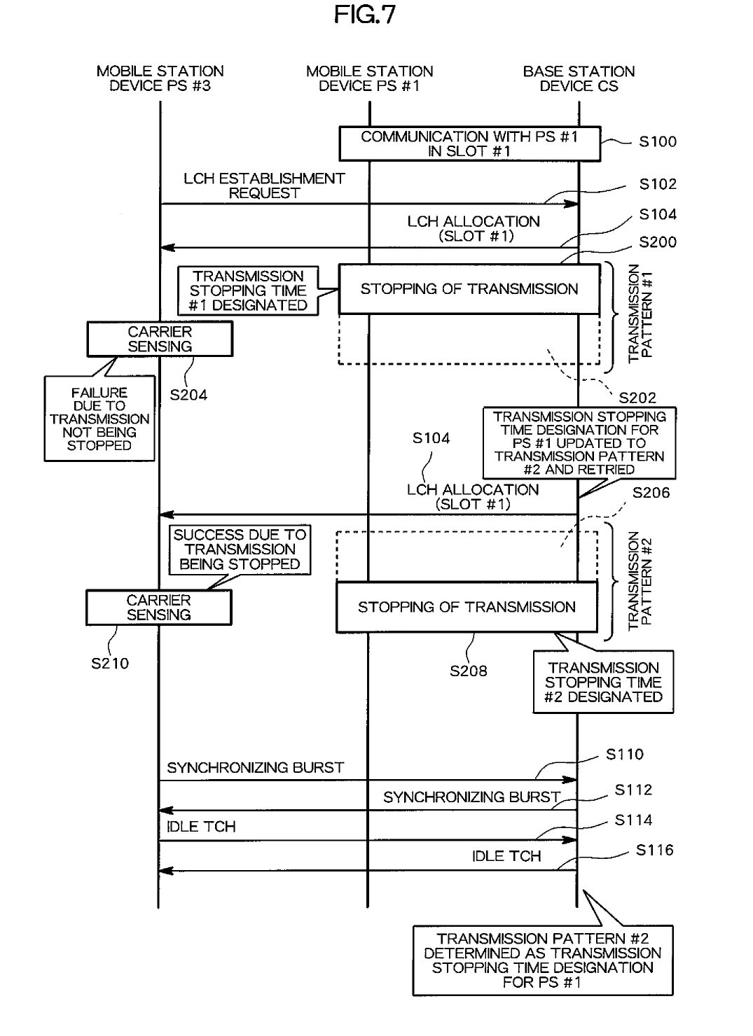

Below, in FIGS. 7 through 9, processing that is substantially the same as the processing in FIG. 11 will be indicated by the same symbols, so that a redundant description is omitted.

FIG. 7 is a sequence diagram of the processing for spatially multiplexing the call 3 on the channel 1. As a result of this processing, the allocation state of the communication channels changes from the state shown in FIG. 10(a) to the state shown in FIG. 10(b) (or FIG. 6(a)). The processing shown in FIG. 7 is the same as the processing illustrated in FIG. 11 except for the stoppage of transmission to PS1 (S106) and the carrier sensing (S108). In the processing shown in FIG. 7, after CS notifies PS3 of the information relating to channel 1 (S104), the transmission control unit 22 retrieves one of the transmission patterns for intermittent transmission stored in the transmission pattern storage unit 32, and performs the intermittent transmission of communication signals to PS1 in accordance with this transmission pattern (S200, S202). For example, in a case where the transmission control unit 22 retrieves the transmission pattern 1 from the transmission pattern storage unit 32 shown in FIG. 3, the transmission to PS1 is continued for one frame period following the processing of S104; subsequently, transmission to PS1 is stopped for a period equal to eight frame periods (S200). Afterward, the transmission control unit 22 resumes transmission to PS1 (S202). In this case, PS3 performs a carrier sense at the timing of S202 in which transmission to PS1 is resumed, and transmission signals from CS to PS1 are detected as interference waves (S204). As a result, the carrier sense cannot be passed, and PS3 cannot make a start request for multiplex communications to CS.

In cases where the start request for multiplex communications from PS3 cannot be received even after a predetermined time preset by a timer or the like has elapsed, CS judges that the carrier sense of PS3 has failed. In this case, the transmission pattern for intermittent transmission to PS1 is changed, and the same processing as described above is performed again. Here, when the stopping of transmission to PS1 is repeated, the frame error rate rises in PS1, and a risk is presented that a handover may be initiated. Accordingly, in order to suppress the occurrence of frame errors in PS1, the stopping of transmission may be limited until a predetermined time has elapsed after the transmission has been stopped once.

In cases where the transmission of communication signals to PS1 is again stopped in order to pass the carrier sense of PS3, the communication channel notification unit 28 of CS notifies PS3 of information relating to the channel 1 (S104). Subsequently, the transmission control unit 22 again retrieves one of the transmission patterns for intermittent transmission from the transmission pattern storage unit 32, and performs the intermittent transmission of communication signals to PS1 in accordance with this transmission pattern (S206, S208). For example, in a case where the transmission control unit 22 retrieves the transmission pattern 2 from the transmission pattern storage unit 32 shown in FIG. 3, transmission to PS1 is continued for 12 frame periods (S206) following the processing of S104; then, transmission to PS1 is stopped for six frame periods (S208). Then, the transmission control unit 22 subsequently resumes transmission to PS1. In this case, since PS3 performs a carrier sense at the timing of S208 when transmission to PS1 is stopped, no transmission signal from CS to PS1 is detected, and the carrier sense is passed (S210). When the carrier sense is passed, PS3 establishes synchronization with CS (S110, S112), and starts the transmission and reception of communication signals (S114, S116). Even if the carrier sense of PS3 again fails in S210, CS repeats a similar process while varying the transmission pattern for intermittent transmission to PS1 until the carrier sense of PS3 is passed.

Furthermore, in the abovementioned processing sequence, an example in which the stopping of transmission to PS1 is repeated is shown. However, it would also be possible to devise the system so that the stopping of transmission for calls in the same time slot is not repeated, by altering the slot for multiplexing or the like after a carrier sense has failed, in order to suppress the occurrence of frame errors in PS1. For example, in a case where PS3 performs a carrier sense in S204 of FIG. 7 and CS judges that the carrier sense has failed, the communication channel notification unit 28 of CS sends information relating to channel 2 in the LCH allocation of S104 to PS3 after a predetermined time has elapsed. Then, the transmission control unit 22 retrieves one of the transmission patterns for intermittent transmission from the transmission pattern storage unit 32, and intermittently transmits communication signals to the terminal (e.g., PS2) using the channel 2 (e.g., slot 2) in accordance with this transmission pattern.

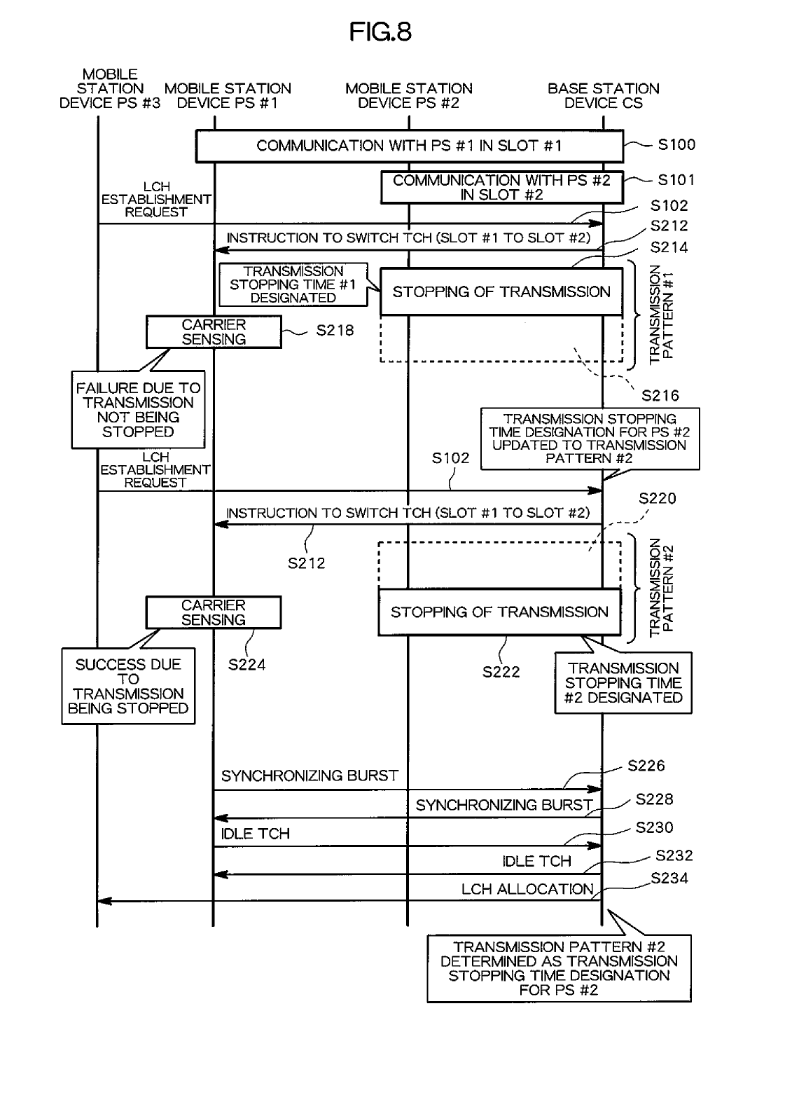

FIG. 8 is a sequence diagram of the processing for spatially multiplexing the call 1 on the channel 2. As a result of this processing, the allocation state of the communication channels changes from the state shown in FIG. 10(a) to the state shown FIG. 6(b). In the initial state shown in FIG. 10(a), PS1 is in communication with CS via channel 1 (S100), and PS2 is in communication with CS via channel 2 (S101). Here, when PS3 transmits a connection request signal (LCH establishment request signal) to CS (S102), CS determines a communication channel that is to be allocated to PS3. In the example shown in FIG. 6(b), call 1 of PS1 that is in communication via channel 1 is selected as a multiplex call in the channel allocation control unit 24, and slot 2 allocated to the call 2 of PS2 is selected as a slot for multiplexing by the slot for multiplexing selection unit 26. The channel allocation control unit 24 then performs a control for allocating channel 1 which is an idle channel to PS3 as a result of the moving of PS1 to channel 2. The communication channel notification unit 28 notifies PS1 of information relating to channel 2 selected by the slot for multiplexing selection unit 26, and an instruction is given that the communication channel is to be switched from channel 1 to channel 2 (S212). In concrete terms, information including the slot 2 and the carrier frequency used in slot 2 is sent to PS1 by the communication channel notification unit 28. Below, the stoppage of transmission to PS2 (S214, S216) and the carrier sense performed by PS1 (S218, S224) have substantially the same processing content as the stoppage of transmission to PS1 (S200, S202) and the carrier sense performed by PS3 (S204, S210) in FIG. 7 except for the fact that the type of mobile station devices 14 is different; accordingly, a description of this process is omitted. When PS1 passes the carrier sense in S224, and channel 2 is multiple-allocated to PS1 (S226, S228), communication on channel 2 is started between PS1 and CS (S230, S232). Consequently, channel 1 becomes an idle channel, and from S234 on, allocation of channels to PS3, including carrier sensing by PS3, is performed.

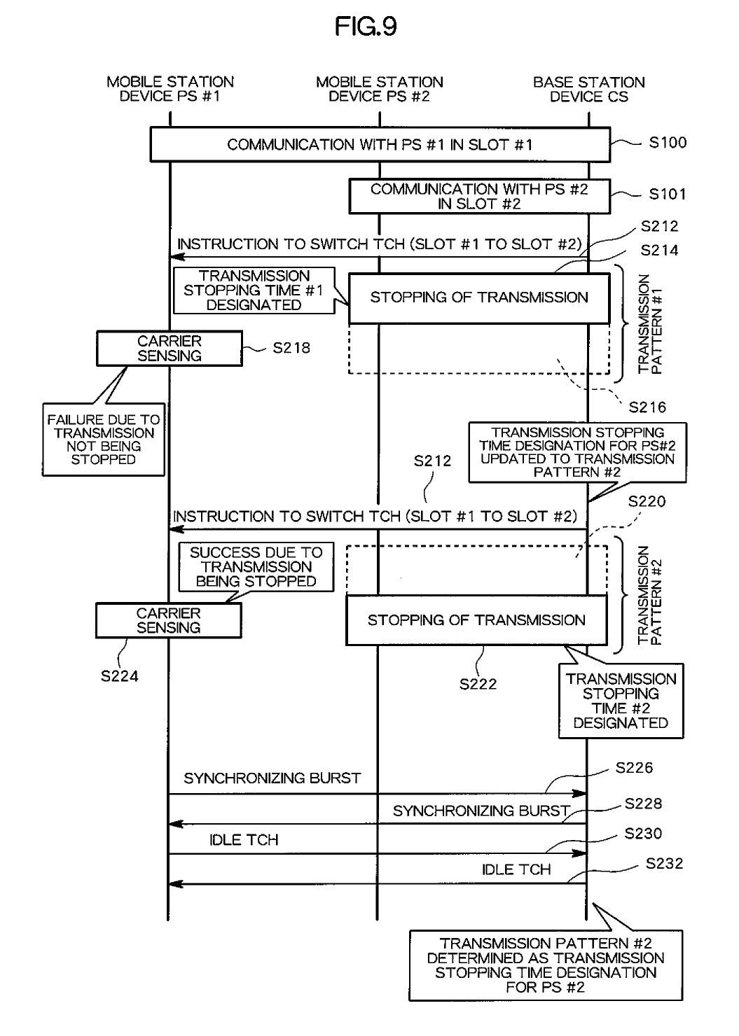

FIG. 9 is a sequence diagram of the processing for spatially multiplexing the call 1 on the channel 2. As a result of this processing, the allocation state of communication channels changes from the state shown in FIG. 10(a) to the state shown in FIG. 6(c). The processing shown in FIG. 9 is processing in which the processing of PS3 is omitted from the processing shown in FIG. 8; accordingly, a description of this process is omitted here.

According to the base station device and control method for the base station device described above, the occurrence of frame errors caused by carrier sensing performed in space division multiple allocation can be suppressed, and the success rate of space division multiple allocation can be improved.

Furthermore, the present invention is not limited to the embodiment described above. For example, in the embodiment described above, an example of a mobile communication system using both time division multiple access and space division multiple access is indicated. However, the present invention can also be applied to a system using only space division multiple access, or to a system combining some other multiplexing scheme with space division multiple access.

Furthermore, the mobile station devices described above may include carrier sense timing notification means, and notify the base station device of their own carrier sense timing information (carrier sense start timing, time required for a carrier sense, or the like).

1. A base station device which is capable of multiplex communications with a plurality of mobile station devices using space division multiple access on a communication channel at a specified carrier frequency, receives a start request for multiplex communications from the mobile station device in accordance with a presence or absence of another communication signal on the communication channel, and allocates the communication channel to the mobile station device that has made the start request in response to the start request, the base station device comprising:
transmission control means for performing intermittent transmission of communication signals to the mobile station device already in communication on the communication channel among the plurality of mobile station devices.

2. The base station device of claim 1, wherein the transmission control means performs the intermittent transmission of the communication signals to the mobile station device already in communication on the communication channel among the plurality of mobile station devices, after notification of the communication channel is provided to the mobile station device that has made the start request.

3. The base station device of claim 1, further comprising transmission pattern storage means for storing a plurality of transmission patterns for the intermittent transmission, wherein the transmission control means retrieves one of the transmission patterns stored in the transmission pattern storage means, and intermittently transmits the communication signals to the mobile station device already in communication on the communication channel among the plurality of mobile station devices, in accordance with this transmission pattern.

4. The base station device of claim 1, further comprising successful transmission pattern storage means for storing the transmission pattern for the intermittent transmission performed by the transmission control means in association with identification information for the mobile station device that has made the start request, wherein
in a case where a start request is again made by the mobile station device that has made the start request, the transmission control means retrieves the transmission pattern stored in the successful transmission pattern storage means in association with identification information for this mobile station device, and intermittently transmits communication signals to the mobile station device already in communication on the communication channel among the plurality of mobile station devices, in accordance with this transmission pattern.

5. The base station device of claim 3 or 4, wherein the transmission pattern includes information specifying a timing at which the transmission of the communication signals to the mobile station device already in communication on the communication channel among the plurality of mobile station devices is stopped, and a period for which the transmission is stopped.

6. The base station device of any one of claims 1 through 4, wherein
the transmission control means limits the stopping of the transmission of the communication signals on the communication channel until a predetermined period of time has elapsed after once stopping the transmission of the communication signals on the communication channel.

7. The base station device of any one of claims 1 through 4, wherein the transmission control means initiates transmission after once stopping the transmission of the communication signals on the communication channel, and stops the transmission on a communication channel differing from the communication channel on which the transmission of the communication signals was once stopped when the transmission is again stopped.

8. The base station device of any one of claims 1 through 4, wherein
the base station device is capable of multiplex communications with the plurality of mobile station devices using time division multiple access and space division multiple access;
the base station device comprises slot for multiplexing selection means for selecting any one of time slots already allocated to at least one of the mobile station devices other than the mobile station device that has made the start request as a slot for multiplexing that is allocated to the mobile station device that has made the start request; and
the communication channel is specified by the slot for multiplexing selected by the slot for multiplexing selection means and the specified carrier frequency.

9. A control method for a base station device which is capable of multiplex communications with a plurality of mobile station devices using space division multiple access on a communication channel at a specified carrier frequency, receives a start request for multiplex communications from the mobile station device in accordance with a presence or absence of another communication signal on the communication channel, and allocates the communication channel to the mobile station device that has made the start request in response to the start request, wherein
communication signals are intermittently transmitted to the mobile station device already in communication on the communication channel among the plurality of mobile station devices.
